(19) United States
(12) Patent Application Publication
(10) Pub. No.: US 2015/0128058 A1
(43) Pub. Date: May 7, 2015

(54) SYSTEM AND METHOD FOR PREDICTIVE ACTIONS BASED ON USER COMMUNICATION PATTERNS

(71) Applicant: AVAYA INC., BASKING RIDGE, NJ (US)

(72) Inventor: Sarangkumar Jagdishchandra Anajwala, Surat (IN)

(73) Assignee: AVAYA INC., BASKING RIDGE, NJ (US)

(21) Appl. No.: 14/072,344

(22) Filed: Nov. 5, 2013

(51) Int. Cl. H04L 29/08; G06F 3/0484; G06F 3/0481

(52) U.S. Cl. CPC H04L 67/22; G06F 3/04817; G06F 3/04842
USPC 715/739

(57) ABSTRACT

Disclosed herein are systems, methods, and computer-readable storage media for identifying, providing, and launching predictive actions, as well as remote device based predictive actions. An example system identifies a communication event such as a calendar event, an incoming communication, an outgoing communication, or a scheduled communication. The system identifies a context for the communication event, and retrieves, based on the context, an action performed by a user at a previous instance of the communication event. The system retrieves the action from a set of actions associated with at least part of the context, and wherein the action exceeds a threshold affinity with the context. The system presents, via a user interface, a selectable user interface object to launch the action. Upon receiving a selection of the selectable user interface object, the system can launch the action.

### BACKGROUND

1. Technical Field

The present disclosure relates to user interfaces for communications and more specifically to suggesting predictive actions for specific communication events and contexts.

2. Introduction

As users communicate with modern technology in increasingly connected environments, especially in business, users often perform certain actions when receiving or placing a telephone call. For example, when a secretary receives an incoming call from the office manager, the secretary may open the electronic calendar that the secretary manages for the office manager. In many real-world scenarios, users manually perform many complex, multi-step processes upon receiving or making a phone call, joining a video conference, and so forth. Often, these complex, multi-step processes are repetitive and predictable, but cause the user to expend mental effort to recall which actions to perform, and also waste time because the user spends time clicking around on his or her computer to ‘set up’ for the phone call or video conference or other communication. Users rely on memory and habit, which can lead to errors, delays, and forgetting to open needed resources, documents, or programs.

Further, users are increasingly mobile, taking incoming communications on multiple end devices, so that users must deal with how to accomplish desired actions on different devices, if those desired actions are even available.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In a non-limiting, illustrative use case, Alice has a weekly conference call with Bob and his development team. When Alice dials in to the weekly conference call, she typically opens her status report spreadsheet, starts recording the call, and opens a blank word processing document for taking notes under a heading indicating the date. The systems and methods disclosed herein can track this behavior of Alice, and learn Alice's behavior patterns. Then, the system associate particular actions of Alice with a particular communication events and contexts after some predictive threshold has been crossed indicating that Alice is likely to perform these one or more actions under the conditions of a similar communication event and context. The system can then provide an interface for Alice to easily execute these predictive actions. For example, the system can present an icon or button through which Alice can execute each of the predictive actions, such as opening the status report spreadsheet, starting to record the call, and opening a blank document. The system can present separate buttons for each predictive action, or can present a single button that executes all the identified predictive actions. In another variation, such as when the communication event is an incoming communication such as a telephone call or video conferencing request, the system can generate a button, link, or icon through which Alice can simultaneously execute the predictive action or actions and answer the incoming communication. For example, the system can present an “answer call” button and an “answer call and open status report spreadsheet” button. In this way, Alice can select whether to execute the action with the incoming telephone call with a single click.

This approach allows Alice to reliably recall which actions are associated with a given communication event and context, and then to easily execute those actions as appropriate. Alice can easily perform predictive, repetitive actions in a single click. The system, whether Alice's local device or a network based device, can track Alice's activity in various communication contexts, and learn from her activity which communication events and/or contexts are triggers which cause Alice to perform certain actions on a consistent basis. This approach differs from the majority of call center automation in that a specific call flow or communication task is not defined in advance by some kind of rule set. The system learns from Alice's behavior which actions are associated with which events and predicts actions based on later events.

Disclosed are systems, methods, and non-transitory computer-readable storage media for launching a predictive action for a communication event. An example system configured to practice the method identifies a communication event. The communication event can be a calendar event, an incoming communication, an outgoing communication, or a scheduled communication, for example. Many of the examples set forth herein will be discussed in terms of an incoming telephone call, but are not limited to that specific type of communication event.

The system can identify a context for the communication event, and retrieve, based on the context, an action performed by a user at a previous instance of the communication event. The action can be identified by machine learning based on an analysis of previous user actions. The user can train the system in a ‘training period’ where the system observes specific behaviors and communication events, or can simply observe user behavior over a period of time to learn patterns. Some example actions include opening a document, viewing contact details, executing a program, creating a file, creating a new entry in a database, or changing a setting. The action can include a set of sub-actions. The system can retrieve the action from a set of actions associated with at least part of the context, and wherein the action exceeds a threshold affinity with the context. For example, the system can identify a set of 5 different predictive actions, and present the best predictive action or the N-best list of predictive actions. In one example, the system selects predictive actions based on actions that are performed at least a threshold amount of previous times. The threshold amount may change over time so that actions which were once frequent but are no longer frequent may ‘age’ off the list.

The system can present, via a user interface, a selectable user interface object to launch the action. In one variation, the system can present ‘new’ user interface objects, but the system can also modify existing user interface objects.

Upon receiving a selection of the selectable user interface object, the system can launch the action. When the communication event is an incoming communication, such as a telephone call or a request for a video conference, the system can set up the selectable user interface object so that selecting the selectable user interface object launches the action and answers the incoming communication with a single action.

Also disclosed herein are systems, methods, and non-transitory computer-readable storage media for identifying and providing predictive actions. In this embodiment, the system can track communication events associated with a user. The system can track communication events in a single device, or can track communication events across multiple communication devices. The system tracking the communication events can be the same system that receives and handles the communication events. The system tracking the communication events can be a remote device, such as a telecommunications server, while the events are directed to a local device, such as a telephone handset, video conference endpoint, or a smartphone.

The system can identify user-initiated actions launched in association with the communication events, and contexts for the user-initiated actions.

When a user-initiated action is launched in association with a communication event more than a threshold number of times, the system can associate the user-initiated action with a context of the communication event to yield a predictive action.

Upon detecting, at a user communication device, the context and a new communication event, the system can provide a suggestion to launch the predictive action on the user communication device. The suggestion can be instructions for placing a one-click icon on user communication device for launching the predictive action. The user communication device in this step can be different from the device on which the communication events were detected previously. In other words, the system can associate communication events, user-initiated actions, and particular contexts on one set of devices, and apply those some associations to communications and contexts on completely different devices.

The system can optionally track user interactions with the predictive action, such as whether or not the user uses the predictive action, whether the user uses the predictive action but makes some changes to it, such as scrolling to a different page in a document, revising the title of the document, or closing a program launched by the predictive action before the end of the communication event. Then the system can update at least one of the context or the predictive action based on the user interactions.

Also disclosed herein are systems, methods, and non-transitory computer-readable storage media for providing predictive actions via a remote device such as a server or network-based computer. An example system, as a remote device, can track communications data, context data, and user-initiated actions of a client device. An example remote device is a server in a telecommunications network, while example client devices can include smartphones, video conferencing equipment, a tablet computing device, a laptop or desktop, a desk phone, wearable computing devices, and so forth. The client device can transmit to the remote device data describing a user activity and details about the action.

The system can generate, based on a relationship between the communications data, context data, and user-initiated actions, a predictive action having a trigger made up of a communication event and a context. Upon detecting, at the client device, conditions that satisfy the trigger, the system can transmit instructions to the client device to present a selectable user interface object to launch the predictive action. For example, a server can transmit instructions to a smartphone to launch the predictive action. In an integrated approach where the server also handles routing communications, the server can send a single notification to the smartphone of the incoming telephone call that also includes the instructions for launching the predictive action. In another variation, the server can send the notification of the incoming telephone call and the instructions separately but either back-to-back or within some threshold time after or before the incoming telephone call. The server can transmit instructions to the client device to present selectable user interface objects for multiple predictive actions. The selectable user interface object can launch multiple predictive actions via a single click.

### BRIEF DESCRIPTION OF THE DRAWINGS

FIG. 1 illustrates an example an example communications system architecture;

FIG. 2 illustrates an example user interface of a client communications device with predictive actions;

FIG. 3 illustrates an example method embodiment for launching a predictive action for a communication event;

FIG. 4 illustrates an example method embodiment for identifying and providing predictive actions;

FIG. 5 illustrates an example method embodiment for providing predictive actions via a remote device; and

FIG. 6 illustrates an example system embodiment.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure. The present disclosure addresses identifying and presenting context-specific contact information in a non-obtrusive way. Multiple variations shall be described herein as the various embodiments are set forth.

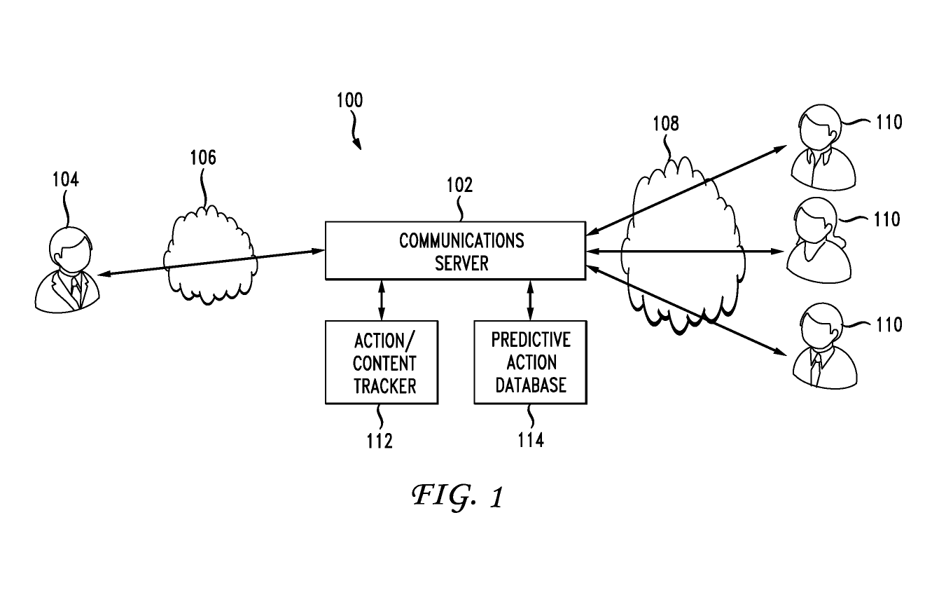

FIG. 1 illustrates an example an example communications system architecture 100. In this architecture, a communications server 102 handles incoming and outgoing communications for a client 104 using a client device such as a VoIP phone, telephone, video conferencing solution, instant messenger, smartphone, desk phone, or other communication device. The communications server 102 relays communication requests and other communications data from other clients 110 to client 104. As the communications server 102 establishes communications between clients, the communications server 102 can track, via the action/content tracker 112 which communication events and communication contexts are associated with which actions the client 104 executes on the client device, such as a smartphone or telephone, or on a companion device, such as a desktop computer or tablet. Communication events can include outgoing and incoming communications. The communications server 102 can continuously track communication events, contexts, and user-executed actions on the client device, and associate detected actions with incoming communication(s) and/or contexts within a threshold period of time prior to the detected actions. In an alternate embodiment, the communications server 102 can track user-initiated actions and determine whether those actions are associated with an incoming communication. The communications server 102 communicates with clients 104, 110 via various networks 106, 108.

Upon detecting an action, the action/context tracker 112 can populate or update part of the predictive action database 114 with data describing the relationship between the action and the context and/or communication event that led up to the user performing the action. The predictive action database 114 can store individual instances of data tuples of action-context-communication event, or can store relationship scores indicating the sum of the associations or relationships between an action, a context, and a communication event. After the predictive action database 114 is populated and has tracked information for a particular client 104, when the communications server 102 detects a communication event and/or context that is a sufficient match to an entry in the predictive action database 114, the communications server 102 fetches the corresponding action and transmits instructions to the device of client 104 to make that action available for the client 104 to select.

The client 104 may roam between multiple devices, or may even use multiple devices simultaneously. The system can track actions performed on one device while the context and/or the communication event occurs on another device. For example, if the user receives a telephone call via a cellular telephone from a scheduling manager, the user may wake up his or her laptop computer and open a scheduling spreadsheet. The communications server 102 and action/context tracker 112 can collect this information from multiple devices for storing or updating information in the predictive action database 114. The predictive action database 114 can further store user preferences for which device the user is more likely to desire to perform a given predictive action.

When the client 104 uses multiple devices, the devices available to the client 104 may change as the client 104 or devices move from location to location. The communications server 102 and/or the predictive action database 114 can store an abstracted action that a translation layer, not shown, can convert to device-specific instructions for available devices based on the devices' abilities. For example, if the action is opening a word processing document, but the available device for the client 104 is incapable of opening the document directly due to software or hardware limitations, the communications server 102 can convert the word processing document to a PDF, a plain text file, or provide instructions to the available device to open an HTML5-based document viewer. The system 100 can adapt the abstracted action in other ways as well, and can adapt an abstracted action in parallel in multiple, different ways for different available devices for a given context and/or communication event. The abstracted action can be based on a specific device type, or can be independent of any single device's abilities. The abstracted action can describe the maximum functionality for each available feature for each device or device type, and can define a preferred implementation of the abstracted action for various specific device types. The system can learn these preferences from user behavior or interactions. Further, if a particular action isn't available or possible on an available device, the communications server 102 can make a combination of sub-actions that approximate or are roughly equivalent, when combined, to a desired predictive action. In this way, the system can provide a next-best action given the capabilities of the device.

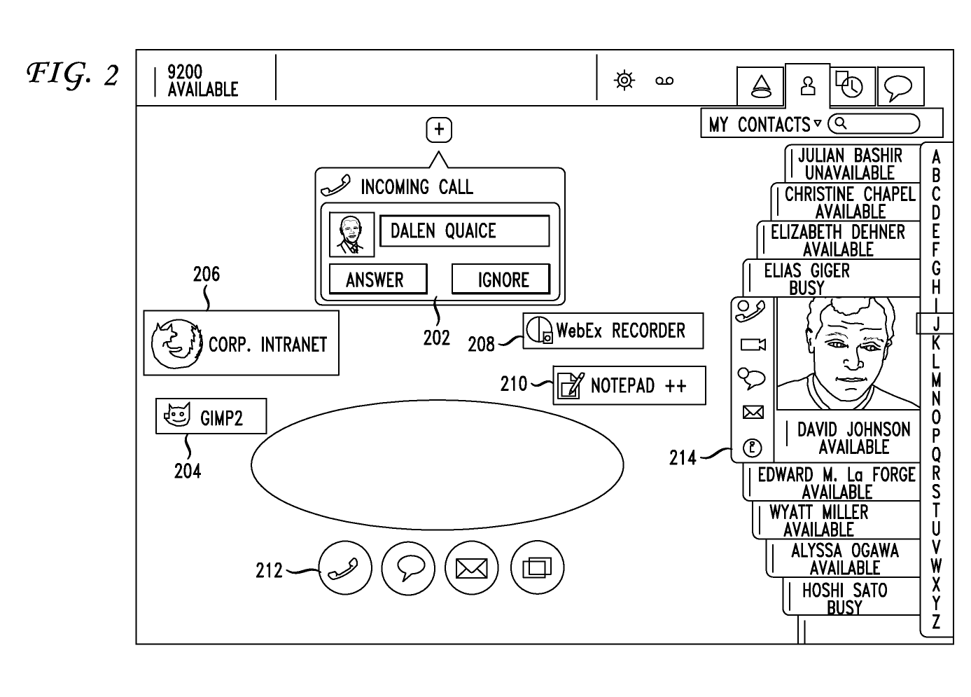

FIG. 2 illustrates an example user interface of a client communications device with predictive actions. In this example, when the user of the user interface receives a telephone call from someone in management, he typically performs certain repetitive actions. For example, the user can perform one or more of launching GIMP 204, opening a browser to access the corporate intranet site 206, opening a WebEx recorder 208, or opening a management status report document in Notepad++ 210. The set of actions can be different for the user's communications or contexts with different persons. The user performs the same repetitive steps for each call from someone in management above some threshold percentage or above some minimum number of times to trigger the inclusion of that action as a predictive action.

By tracking a user's action on call with each of his contacts, the system learns what actions the user performs normally while on call with a particular contact. Then, based on the learning, the system provides ‘predictive actions’ to the user's device to so the user has one-click access to execute the predictive actions. In this example, when the user receives an incoming telephone call from Dalen Quaice 202, who we assume for purposes of illustration is a member of management, the system can select and present predictive actions that were determined based on frequently performed actions. So, either as the notification of the incoming call 202 is shown or slightly thereafter, the system can present one-click options 204, 206, 208, 210 to launch the various predictive actions associated with incoming telephone calls from Dalen Quaice. The system would display different predictive actions for incoming calls from different individuals. The system can classify individuals in groups, so that an incoming call from any individual from the group is associated with the same predictive actions. The predictive actions can be associated with context and/or a communication event, so that the system can present predictive actions in the absence of an incoming telephone call.

In this way, the system can learn a user's communication patterns, and apply the learned patterns to predict what the user is likely to do for a particular communication event and/or context. The system generates, highlights, or provides a simple way for the user to launch those actions. In one example, the system can modify existing user interface elements, such as a list of contacts as a predictive action. For example, if the system determines that the predictive action is to conference in David Johnson, the system can scroll the list of contacts to focus on or center on David Johnson 214 in the list of contacts. Similarly, the system can modify or replace existing buttons 212, such as the existing buttons for placing a phone call, sending an instant message, sending an email, and so forth, to perform predictive actions. The system can combine multiple predictive actions into a single one-click button, and can even combine predictive actions with a button to respond to an incoming communication. For example, the incoming call dialog 202 shows an “Answer” button, but the system could incorporate the WebEx Recorder button 208, to provide a third option in the incoming call dialog 202, so in addition to the “Answer” button, the system also displays an “Answer+start WebEx Recorder” button.

The system can track user activity reported in various formats. A local communications device can track and store user activity, or the local device can transmit user activity data to a server. One example data model for storing or transmitting user activity data is provided below.

```
      UserActivity:  {userActivityId,  userId,  remotePartyId,
callDirection, callStartTime, callEndTime, actionDetails[ ]}
      ActionDetails: {actionType, actionName, startTime, endTime,
      actionDetails[ ]}
```

Sample data is provided below, to illustrate how this format is used to convey data.

```
<UserActivity>
<UserActivityId> 1 </UserActivityId>
<UserId> 1 </UserId>
<RemotePartyId> 1 </RemotepPartyId>
<CallDirection> incoming </CallDirection>
<CallStartTime> 2013-03-05 10:00:00 </CallStartTime>
<CallEndTime> 2013-03-05 10:30:00 </CallEndTime>
<Action Details>
      <ActionType> ToolAccess </ActionType>
      <ActionName> Mozilla Firefox </ActionName>
      <StartTime> 2013-03-05 10:05:05 </StartTime>
      <EndTime> 2013-03-05 10:25:05 </EndTime>
      <ActionDetails>
            <ActionType>URL Access</ActionType>
            < ActionName>patents.google.com </ActionName>
            <StartTime> 2013-03-05 10:05:05 </StartTime>
            <EndTime> 2013-03-05 10:20:05 </EndTime>
      </ActionDetails>
      <ActionDetails>
            <ActionType>URL Access</ActionType>
            < ActionName> www.avaya.com </ActionName>
            <StartTime> 2013-03-05 10:20:05 </StartTime>
            <EndTime> 2013-03-05 10:25:05 </EndTime>
      </ActionDetails>
</ActionDetails>
```

The server can send predictive action instructions to the client device using a similar or the same format, as shown below.

PredictiveActions: {actionDetails[ ]}->array of actions

The disclosure turns now to a discussion of the algorithm for analyzing user activity and ranking the actions to facilitate retrieval of predictive actions based on the predictive ranking. The example algorithm is discussed in terms of a client and a server for purposes of illustration, but can be implemented in different configurations, such as entirely on the client side. The client transmits ‘UserActivity’ data to the server after each communication event, such as an incoming telephone or Voice over IP call. The server saves the raw ‘UserActivity’ data in persistent store, such as a database. The system can include or communicate with an analyzer that executes at some regular interval to read ‘UserActivity’ data from persistent store. The analyzer can process the ‘ActionDetails’ of the ‘UserActivity’ data, compare the ‘ActionDetails’ with rankings of previous data, and accordingly modify rankings using example algorithms discussed herein. Other algorithms or modifications to these algorithms can be used instead to meet specific predictive actions or specific usage patterns.

A first algorithm based on frequency is shown below.

Frequency_{AiPx}=(CountOfAction_{AiPx}/TotalCountOfCalls_{Px})

where Frequency_{AiPx} is the ratio of frequency of occurrence of action Ai with respect to total calls with Person Px, CountOfAction_{AiPx} is the number of times action Ai is performed during calls with Person Px, and TotalCountOfCalls_{Px} is the total number of calls with person Px.

A second algorithm based on duration is shown below.

Duration_{AiPx}=(DurationOfAction_{AiPx}/TotalDurationOfCalls_{Px})

where DurationAiPx is the ratio of time spent performing action Ai with respect to total call duration with person Px, DurationOfAction_{AiPx} is the time spent performing action Ai during calls with person Px, and TotalDurationOfCalls_{Px} is the total time spent in calls with person Px.

A third algorithm based on average duration is shown below.

AvgDuration_{AiPx}=(DurationOfAction_{AiPx}/TotalCountOfCalls_{Px})

where AvgDuration_{AiPx} is the average time spent performing action Ai per call with person Px, DurationOfAction_{AiPx} is the time spent performing action Ai during calls with person Px, and TotalCountOfCalls_{Px} is the total number of calls with person Px.

The system can then compare two predictive rankings to determine whether they are a sufficient match. An example algorithm for comparing two predictive rankings, PredictiveRanking_{PxAi} and PredictiveRanking_{PxAj}, is provided below, where PredictiveRanking_{PxAi} is the Predictive Ranking of action Ai for Contact Px, and PredictiveRanking_{PxAj} is the Predictive Ranking of action Aj for Contact Px.

The system calculates FreqDiff_{PxAiAj} as Frequency_{AiPx}−Frequency_{AjPx} where Frequency_{AiPx} is greater than Frequency_{AjPx}. Then the system can apply the algorithm outlined in the pseudo code below:

```
If (FreqDiff_{PxAiAj} < MIN_THREASHOLD_FREQ_DIFF) {
      DiffAvgDuration_{PxAiAj} = AvgDuration_{AiPx} − AvgDuration_{AiPx}
            # where AvgDuration_{AiPx} > AvgDuration_{AiPx}
      If (DiffAvgDuration_{PxAiAj} <
      MIN_THREASHOLD_AVGDURATION_DIFF)
      {
            If (Duration_{AiPx} > Duration_{AjPx}) {
                  PredictiveRanking_{PxAi} > PredictiveRanking_{PxAj}
            } else {
                  PredictiveRanking_{PxAi} < PredictiveRanking_{PxAj}
            }
      } else {
            If (AvgDuration_{AiPx} < AvgDuration_{AiPx}) {
                  PredictiveRanking_{PxAi} > PredictiveRanking_{PxAj}
            } else {
                  PredictiveRanking_{PxAi} < PredictiveRanking_{PxAj}
            }
      }
} else {
      If (Frequency_{AiPx} > Frequency_{Ajpx}) {
      PredictiveRanking_{PxAi} > PredictiveRanking_{PxAj}
      } else {
            PredictiveRanking_{PxAi} < PredictiveRanking_{PxAj}
      }
}
```

Using the example algorithm above, the system determines PredictiveRanking_{Ai} for each Action Ai and uses this ranking to return the ‘Predictive Actions’ to the client device, such as at the beginning of a telephone call or upon some other communication event. In this way, the system can identify and suggest predictive actions to a user that are relevant, and that are based on the user's previous patterns of behavior given a similarity between the context of past actions and a current context. The system can automate exposing or suggesting predictive actions by learning from the user's communication and behavior patterns.

A network-based service can track user activities broadly, and can extract out or focus on specific actions associated with communication events or telephone calls. The predictive action analyzer can plug in to a backend framework for data mining to analyze user activities and develop learning data from those user activities.

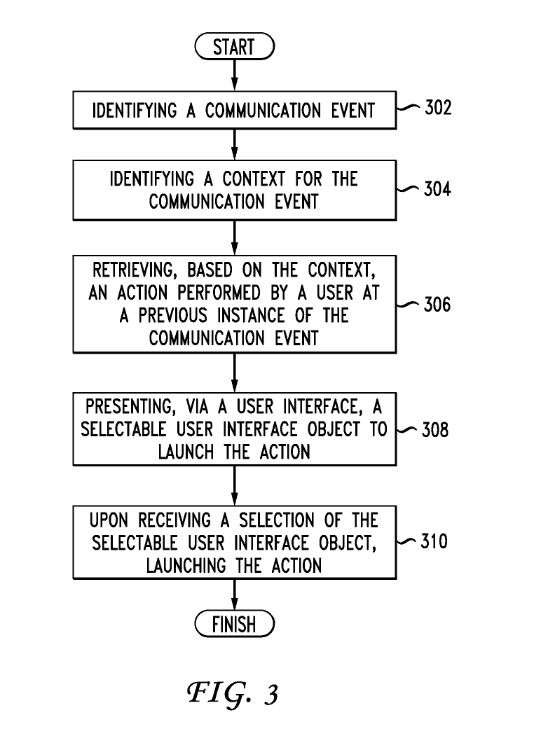

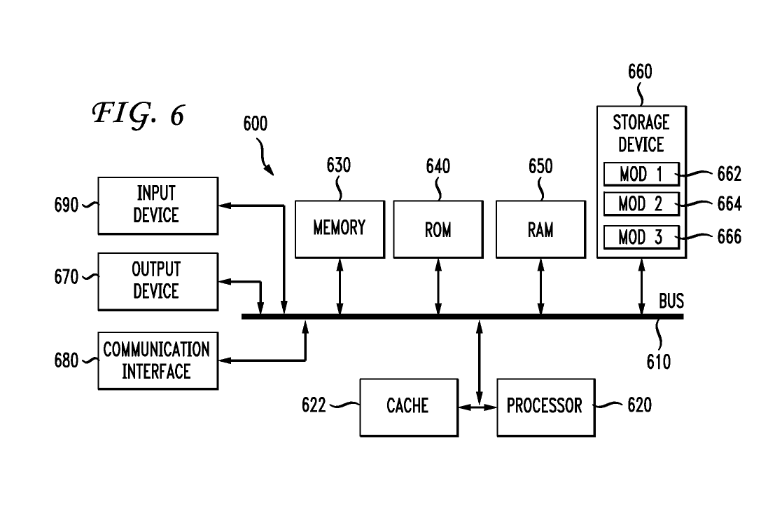

Having disclosed some basic system components and concepts, the disclosure now turns to the exemplary method embodiments shown in FIGS. 3, 4, and 5. For the sake of clarity, the methods are described in terms of an exemplary system as shown in FIG. 6 configured to practice the respective methods. The steps outlined herein are exemplary and can be implemented in any combination thereof, including combinations that exclude, add, or modify certain steps.

FIG. 3 illustrates an example method embodiment for launching a predictive action for a communication event. An example system configured to practice the method identifies a communication event (302). The communication event can be a calendar event, an incoming communication, an outgoing communication, or a scheduled communication, for example. Many of the examples set forth herein will be discussed in terms of an incoming telephone call, but are not limited to that specific type of communication event.

The system can identify a context for the communication event (304), and retrieve, based on the context, an action performed by a user at a previous instance of the communication event (306). The action can be identified by machine learning based on an analysis of previous user actions. The user can train the system in a ‘training period’ where the system observes specific behaviors and communication events, or can simply observe user behavior over a period of time to learn patterns. Some example actions include opening a document, viewing contact details, executing a program, creating a file, creating a new entry in a database, or changing a setting. The action can include a set of sub-actions. The system can retrieve the action from a set of actions associated with at least part of the context, and wherein the action exceeds a threshold affinity with the context. For example, the system can identify a set of 5 different predictive actions, and present the best predictive action or the N-best list of predictive actions. In one example, the system selects predictive actions based on actions that are performed at least a threshold amount of previous times. The threshold amount may change over time so that actions which were once frequent but are no longer frequent may ‘age’ off the list.

The system can present, via a user interface, a selectable user interface object to launch the action (308). In one variation, the system can present ‘new’ user interface objects, but the system can also modify existing user interface objects. Upon receiving a selection of the selectable user interface object, the system can launch the action (310). When the communication event is an incoming communication, such as a telephone call or a request for a video conference, the system can set up the selectable user interface object so that selecting the selectable user interface object launches the action and answers the incoming communication with a single action.

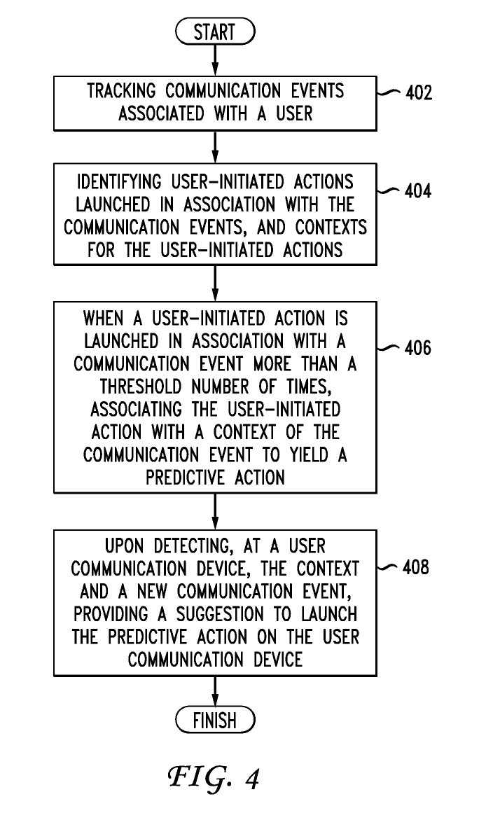

FIG. 4 illustrates an example method embodiment for identifying and providing predictive actions. In this embodiment, the system can track communication events associated with a user (402). The system can track communication events in a single device, or can track communication events across multiple communication devices. The system tracking the communication events can be the same system that receives and handles the communication events. The system tracking the communication events can be a remote device, such as a telecommunications server, while the events are directed to a local device, such as a telephone handset, video conference endpoint, or a smartphone. The system can identify user-initiated actions launched in association with the communication events, and contexts for the user-initiated actions (404). When a user-initiated action is launched in association with a communication event more than a threshold number of times, the system can associate the user-initiated action with a context of the communication event to yield a predictive action (406).

Upon detecting, at a user communication device, the context and a new communication event, the system can provide a suggestion to launch the predictive action on the user communication device (408). The suggestion can be instructions for placing a one-click icon on user communication device for launching the predictive action. The user communication device in this step can be different from the device on which the communication events were detected previously. In other words, the system can associate communication events, user-initiated actions, and particular contexts on one set of devices, and apply those some associations to communications and contexts on completely different devices.

The system can optionally track user interactions with the predictive action, such as whether or not the user uses the predictive action, whether the user uses the predictive action but makes some changes to it, such as scrolling to a different page in a document, revising the title of the document, or closing a program launched by the predictive action before the end of the communication event. Then the system can update at least one of the context or the predictive action based on the user interactions.

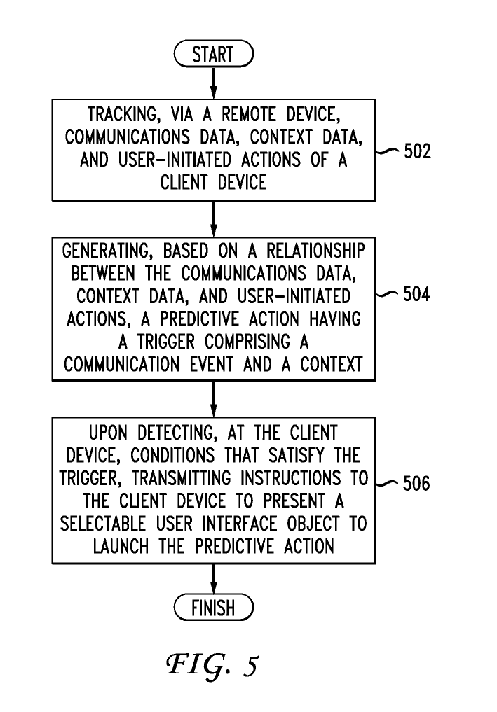

FIG. 5 illustrates an example method embodiment for providing predictive actions via a remote device such as a server or network-based computer. An example remote device can track communications data, context data, and user-initiated actions of a client device (502). An example remote device is a server in a telecommunications network, while example client devices can include smartphones, video conferencing equipment, a tablet computing device, a laptop or desktop, a desk phone, wearable computing devices, and so forth. The client device can transmit to the remote device data describing a user activity and details about the action.

The remote device can generate, based on a relationship between the communications data, context data, and user-initiated actions, a predictive action having a trigger made up of a communication event and a context (504). Upon detecting, at the client device, conditions that satisfy the trigger, the remote device can transmit instructions to the client device to present a selectable user interface object to launch the predictive action (506). For example, the remote device can transmit instructions to a smartphone to launch the predictive action. In an integrated approach where the server also handles routing communications, the remote device can send a single notification to the smartphone of the incoming telephone call that also includes the instructions for launching the predictive action. In another variation, the remote device can send the notification of the incoming telephone call and the instructions separately but either back-to-back or within some threshold time after or before the incoming telephone call. The remote device can transmit instructions to the client device to present selectable user interface objects for multiple predictive actions. The selectable user interface object can launch multiple predictive actions via a single click.

A brief description of a basic general purpose system or computing device in FIG. 6 which can be employed to practice the concepts is disclosed herein. FIG. 6 illustrates an example general-purpose computing device 600, including a processing unit (CPU or processor) 620 and a system bus 610 that couples various system components including the system memory 630 such as read only memory (ROM) 640 and random access memory (RAM) 650 to the processor 620. The system 600 can include a cache 622 of high speed memory connected directly with, in close proximity to, or integrated as part of the processor 620. The system 600 copies data from the memory 630 and/or the storage device 660 to the cache 622 for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, bus 610, display 670, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, read only memory (ROM) 640, a cable or wireless signal containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 620. The functions these blocks represent may be provided through the use of either shared or dedicated hardware, including, but not limited to, hardware capable of executing software and hardware, such as a processor 620, that is purpose-built to operate as an equivalent to software executing on a general purpose processor. For example the functions of one or more processors presented in FIG. 6 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 640 for storing software performing the operations described below, and random access memory (RAM) 650 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 600 shown in FIG. 6 can practice all or part of the recited methods, can be a part of the recited systems, and/or can operate according to instructions in the recited tangible computer-readable storage media. Such logical operations can be implemented as modules configured to control the processor 620 to perform particular functions according to the programming of the module. For example, FIG. 6 illustrates three modules Mod1 662, Mod2 664 and Mod3 666 which are modules configured to control the processor 620. These modules may be stored on the storage device 660 and loaded into RAM 650 or memory 630 at runtime or may be stored in other computer-readable memory locations.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
identifying a communication event;
identifying, via a processor, a context for the communication event;
retrieving, based on the context, an action performed by a user at a previous instance of the communication event;
presenting, via a user interface, a selectable user interface object to launch the action; and
upon receiving a selection of the selectable user interface object, launching the action.

2. The method of claim 1, wherein the communication event comprises one of a calendar event, an incoming communication, an outgoing communication, or a scheduled communication.

3. The method of claim 1, wherein the action comprises at least one of opening a document, viewing contact details, executing a program, creating a file, creating a new entry in a database, or changing a setting.

4. The method of claim 1, wherein the action comprises a plurality of sub-actions.

5. The method of claim 1, wherein the action is retrieved from a set of actions associated with at least part of the context, and wherein the action exceeds a threshold affinity with the context.

6. The method of claim 1, wherein the action was performed at least a threshold amount of previous instances.

7. The method of claim 1, wherein presenting the selectable user interface object further comprises:
modifying an existing user interface object in a graphical user interface.

8. The method of claim 1, wherein presenting the selectable user interface object further comprises:
creating the selectable user interface object as a new user interface object in a graphical user interface.

9. The method of claim 1, wherein the communication event comprises an incoming communication, and selecting the selectable user interface object launches the action and answers the incoming communication.

10. A system comprising:
a processor; and
a computer-readable storage medium storing instructions which, when executed by the processor, cause the processor to perform a method comprising:
tracking communication events associated with a user;
identifying user-initiated actions launched in association with the communication events, and contexts for the user-initiated actions;
when a user-initiated action is launched in association with a communication event more than a threshold number of times, associating the user-initiated action with a context of the communication event to yield a predictive action; and
upon detecting, at a user communication device, the context and a new communication event, providing a suggestion to launch the predictive action on the user communication device.

11. The system of claim 10, further comprising:
tracking communication events across a plurality of communication devices.

12. The system of claim 11, wherein the user communication device is not part of the plurality of communication devices.

13. The system of claim 10, the computer-readable storage medium further storing instructions which result in the method further comprising:
tracking user interactions with the predictive action; and
updating at least one of the context or the predictive action based on the user interactions.

14. The system of claim 10, wherein the suggestion comprises instructions for placing a one-click icon on user communication device for launching the predictive action.

15. A non-transitory computer-readable storage medium storing instructions which, when executed by a computing device, cause the computing device to perform a method comprising:
tracking, via a remote device, communications data, context data, and user-initiated actions of a client device;
generating, based on a relationship between the communications data, context data, and user-initiated actions, a predictive action having a trigger comprising a communication event and a context; and
upon detecting, at the client device, conditions that satisfy the trigger, transmitting instructions to the client device to present a selectable user interface object to launch the predictive action.

16. The non-transitory computer-readable storage medium of claim 15, storing additional instructions which result in the method further comprising:
tracking user interactions with the selectable user interface object on the client device; and
updating at least one of the predictive action or the context based on the user interactions.

17. The non-transitory computer-readable storage medium of claim 15, storing additional instructions which result in the method further comprising:
transmitting instructions to the client device to present selectable user interface objects for a plurality of predictive actions.

18. The non-transitory computer-readable storage medium of claim 15, wherein the selectable user interface object launches a plurality of predictive actions.

19. The non-transitory computer-readable storage medium of claim 15, wherein the communication event comprises an incoming communication.

20. The non-transitory computer-readable storage medium of claim 15, wherein the remote device receives from the client device data describing a user activity and action details.
